(19) United States
(12) Patent Application Publication
(10) Pub. No.: US 2014/0067711 A1
(43) Pub. Date: Mar. 6, 2014

(54) Liquidity Charge Determination

(71) Applicants: Pavan Shah, New York, NY (US); Marco Ossanna, New York, NY (US); Brent Skilton, Aurora, IL (US)

(72) Inventors: Pavan Shah, New York, NY (US); Marco Ossanna, New York, NY (US); Brent Skilton, Aurora, IL (US)

(73) Assignee: CHICAGO MERCANTILE EXCHANGE INC., Chicago, IL (US)

(21) Appl. No.: 13/599,560

(22) Filed: Aug. 30, 2012

(51) Int. Cl. G06Q 40/06

(52) U.S. Cl. 705/36 R

(57) ABSTRACT

A liquidity charge may be determined and added to a performance bond value for a portfolio. The resulting sum may then represent an augmented performance bond value that compensates for expected liquidation cost associated with the portfolio. Liquidation charge data may be stored for each of multiple portfolio types. For each of those portfolio types, the stored data may define possible input values for a pre-augmentation performance bond and liquidity charges based on any of the possible input values. That data may then be used to determine a liquidity charge based on the pre-augmentation performance bond value.

### BACKGROUND

Liquidity risk relates to situations in which a party desiring to trade an asset may not be able to do so because no other participants in a relevant marketplace wish to trade in that asset. For example, a party holding a particular asset may wish to sell. That asset may have value, but there may be little or no current market for the asset. Liquidity risk can represent a potentially significant cost to a party considering purchase of an asset. If there is little or no market for the asset when the asset holder wishes to sell, the holder may be forced to sell at a reduced price, to incur interest charges as a result of holding the asset longer than desired, etc.

Liquidity risk can become a major concern when attempting to dispose of large portfolios. If a holder of a large portfolio defaults, for example, it may be important to find other parties willing to purchase that portfolio so as to minimize losses associated with the default. If potential purchasers expect difficulty when reselling a purchased portfolio, they may reduce the amount they are willing to pay based on that expected difficulty.

In many financial markets, holders of positions in traded assets are required to maintain a minimum balance of cash or other security as a “margin” or performance bond. This performance bond may be used to reduce the risk to other market participants of losses associated with the position holder failing to fulfill its obligations. If a holder of a portfolio goes bankrupt or otherwise defaults, the performance bond for that portfolio can be used to reduce losses resulting from the holder no longer being able to cover its positions. There remains a need for improved systems and techniques to calculate a performance bond value that better accounts for liquidity risk.

### SUMMARY

This Summary is provided to introduce a selection of concepts in a simplified form that are further described below in the Detailed Description. This Summary is not intended to identify key or essential features of the invention.

In at least some embodiments, a liquidity charge may be determined and added to a performance bond value for a portfolio. The resulting sum may then represent an augmented performance bond value that compensates for expected liquidation cost associated with the portfolio. Liquidation charge data may be stored for each of multiple portfolio types. For each of those portfolio types, the stored data may define possible input values for a pre-augmentation performance bond and liquidity charges based on any of the possible input values. That data may then be used to determine a liquidity charge based on the pre-augmentation performance bond value.

Embodiments include, without limitation, methods for determining a liquidity charge and/or methods for calculating an augmented performance bond value that includes a liquidity charge, computer systems configured to perform such methods, and computer-readable media storing instructions that, when executed, cause a computer system to perform such methods.

### BRIEF DESCRIPTION OF THE DRAWINGS

Some embodiments are illustrated by way of example, and not by way of limitation, in the figures of the accompanying drawings and in which like reference numerals refer to similar elements.

FIG. 1 shows an exemplary trading network environment for implementing systems and methods according to at least some embodiments.

FIG. 2 is a flow chart showing operations in a process performed by an exchange computer system, in at least some embodiments, to determine a liquidity charge based on a performance bond value of a portfolio and to calculate an augmented performance bond that includes the determined liquidity charge.

FIG. 3 shows a generic liquidity charge data accessed by an exchange computer system during the process of FIG. 2.

FIG. 4 is a graph illustrating creation of a liquidity charge data set based on a superlinear function for expected liquidation cost versus performance bond amount.

### DETAILED DESCRIPTION

In the following description of various embodiments, reference is made to the accompanying drawings, which form a part hereof, and in which various embodiments are shown by way of illustration. It is to be understood that there are other embodiments and that structural and functional modifications may be made. Embodiments of the present invention may take physical form in certain parts and steps, examples of which will be described in detail in the following description and illustrated in the accompanying drawings that form a part hereof.

Various embodiments may comprise a method, a computer system, and/or a computer program product. Accordingly, one or more aspects of one or more of such embodiments may take the form of an entirely hardware embodiment, an entirely software embodiment and/or an embodiment combining software and hardware aspects. Furthermore, such aspects may take the form of a computer program product stored by one or more non-transitory computer-readable storage media having computer-readable program code, or instructions, embodied in or on the storage media. The term “computer-readable medium” or “computer-readable storage medium” as used herein includes not only a single medium or single type of medium, but also a combination of one or more media and/or types of media. Such a non-transitory computer-readable medium may store executable data such as computer-readable instructions (e.g., software) and/or non-executable computer-readable information. Any suitable computer readable media may be utilized, including various types of non-transitory computer readable storage media such as hard disks, CD-ROMs, optical storage devices, magnetic storage devices, and/or any combination thereof. The term “computer-readable medium” or “computer-readable storage medium” could also include an integrated circuit or other device having hard-coded instructions (e.g., logic gates) that configure the device to perform one or more operations.

Aspects of method steps described in connection with one or more embodiments may be executed on one or more processors associated with a computer system (such as exchange computer system 100 and/or other computers described below). As used herein, a “computer system” could be a single computer or could comprise multiple computers. When a computer system comprising multiple computers performs a method, various steps could be performed by different ones of those multiple computers. Processors of a computer system may execute computer-executable instructions stored on non-transitory computer-readable media. Embodiments may also be practiced in a computer system forming a distributed computing environment, with tasks performed by remote processing devices that are linked through a communications network. In a distributed computing environment, program modules may be located in both local and remote computer storage media including memory storage devices.

### Exemplary Operating Environment

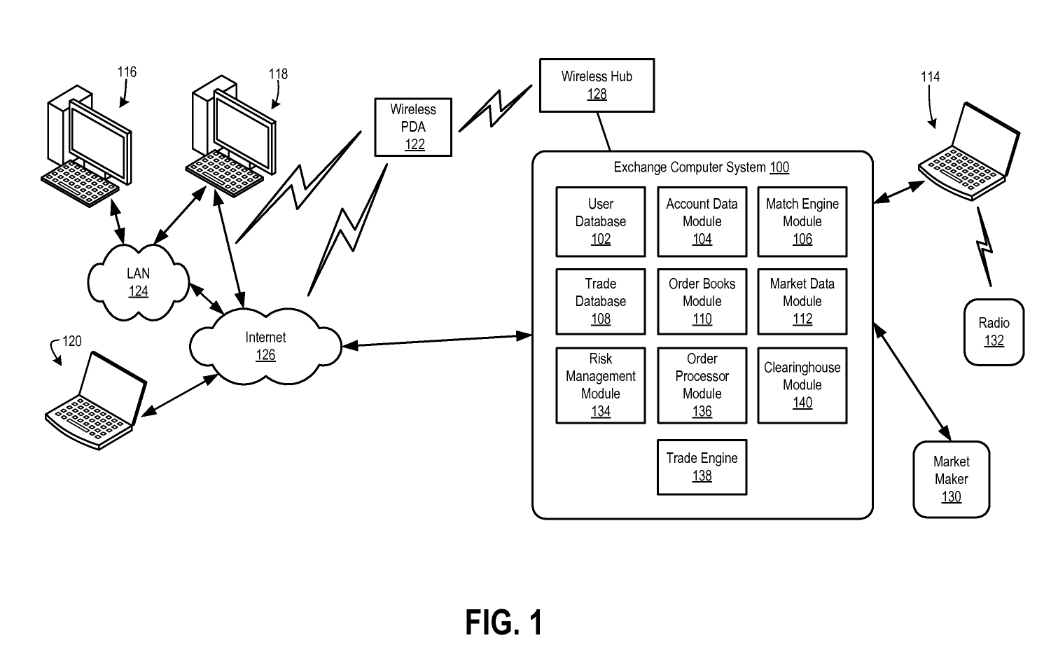

Aspects of at least some embodiments can be implemented with computer systems and computer networks that allow users to communicate trading information and/or otherwise perform operations associated with trading and/or holding positions in financial products. An exemplary trading network environment for implementing systems and methods according to at least some embodiments is shown in FIG. 1. The implemented systems and methods can include systems and methods that determine a liquidity charge and that utilize a determined liquidity charge in ways described more fully below.

Computer system 100 can be operated by a financial product exchange and configured to perform operations of the exchange for, e.g., trading in various financial products. Financial products of the exchange may include, without limitation, futures contracts, options on futures contracts (“futures contract options”), interest rate swaps, and other types of exchange-traded and over-the-counter (OTC) derivative contracts. Computer system 100 receives orders for financial products, matches orders to execute trades, transmits market data related to orders and trades to users, and performs other operations associated with a financial product exchange. Exchange computer system 100 may be implemented with one or more mainframe, desktop or other computers. In one embodiment, a computer device uses a 64-bit processor. A user database 102 includes information identifying traders and other users of exchange computer system 100. Data may include user names and passwords. An account data module 104 may process account information that may be used during trades. A match engine module 106 is included to match prices and other parameters of bid and offer orders. Match engine module 106 may be implemented with software that executes one or more algorithms for matching bids and offers. A trade database 108 may be included to store information identifying trades and descriptions of trades. In particular, a trade database may store information identifying the time that a trade took place and the contract price. An order book module 110 may be included to store prices and other data for bid and offer orders, and/or to compute (or otherwise determine) current bid and offer prices. A market data module 112 may be included to collect market data, e.g., data regarding current bids and offers for interest rate swaps, futures contracts, futures contract options and other derivative products. Module 112 may also prepare the collected market data for transmission to users. A risk management module 134 may be included to compute and determine a user's risk utilization in relation to the user's defined risk thresholds. An order processor module 136 may be included to decompose delta based and bulk order types for further processing by order book module 110 and match engine module 106.

A clearinghouse module 140 may be included as part of exchange computer system 100 and configured to carry out clearinghouse operations. Module 140 may receive data from trade database 108 regarding trades of interest rate swaps, futures contracts and other financial products and facilitate the financial product exchange acting as one of the parties to every traded contract or other product. For example, computer system 100 may match an offer by party A to sell an exchange-traded financial product with a bid by party B to purchase a like exchange-traded financial product. Module 140 may then create an exchange-traded financial product between party A and the exchange and an offsetting second exchange-traded financial product between the exchange and party B. Module 140 may also be configured to perform other clearinghouse operations. As another example, module 140 may maintain margin (performance bond) accounts for clearing members. In those accounts, module 140 may store and maintain data regarding the values of various contracts and other instruments, determine mark-to-market and final settlement amounts, confirm receipt and/or payment of amounts due from margin accounts, confirm satisfaction of final settlement obligations (physical or cash), etc. In some embodiments, clearinghouse module 140 may determine a liquidity charge and use that determined liquidity charge as described below.

Each of modules 102 through 140 could be separate software components executing within a single computer, separate hardware components (e.g., dedicated hardware devices) in a single computer, separate computers in a networked computer system, or any combination thereof (e.g., different computers in a networked system may execute software modules corresponding more than one of modules 102-140).

Computer device 114 is shown directly connected to exchange computer system 100. Exchange computer system 100 and computer device 114 may be connected via a T1 line, a common local area network (LAN) or other mechanism for connecting computer devices. Computer device 114 is shown connected to a radio 132. The user of radio 132 may be a trader or exchange employee. The radio user may transmit orders or other information to a user of computer device 114. The user of computer device 114 may then transmit the trade or other information to exchange computer system 100.

Computer devices 116 and 118 are coupled to a LAN 124. LAN 124 may have one or more of the well-known LAN topologies and may use a variety of different protocols, such as Ethernet. Computers 116 and 118 may communicate with each other and other computers and devices connected to LAN 124. Computers and other devices may be connected to LAN 124 via twisted pair wires, coaxial cable, fiber optics, radio links or other media.

A wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet. Computers 116, 118 and 120 may communicate with each other via the Internet 126 and/or LAN 124.

One or more market makers 130 may maintain a market by providing constant bid and offer prices for a derivative or security to exchange computer system 100. Exchange computer system 100 may also include trade engine 138. Trade engine 138 may, e.g., receive incoming communications from various channel partners and route those communications to one or more other modules of exchange computer system 100.

One skilled in the art will appreciate that numerous additional computers and systems may be coupled to exchange computer system 100. Such computers and systems may include clearing, regulatory and fee systems.

The operations of computer devices and systems shown in FIG. 1 may be controlled by computer-executable instructions stored on non-transitory computer-readable media. For example, computer device 116 may include computer-executable instructions for receiving market data from exchange computer system 100 and displaying that information to a user. As another example, clearinghouse module 140 may include computer-executable instructions for determining a liquidation charge using a process such as is described below, using that liquidation charge to calculate an augmented performance bond value, and using that augmented performance bond value in connection with further processing.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may be connected by numerous alternative topologies.

### Exemplary Embodiments

As previously indicated, liquidity risk relates to situations where a party desiring to trade an asset may be unable to do so. In particular, there may be no other participants in a relevant marketplace which wish to trade in that asset. For example, a party holding a particular asset may wish to sell. That asset may have value, but there may be little or no current market for the asset. Liquidation cost represents a quantification of liquidity risk, and in particular, a cost associated with liquidating a position for which there might be no market. Liquidation cost can be particularly important to a party considering purchase of an asset, as it may affect the subsequent ability of the party to recover its investment. Depending on the asset and market in question, liquidation cost could be manifested in various ways. For example, liquidation cost might represent a cost (or a portion of a cost) of having to sell at a reduced value instead of holding an asset until a market improves. As but another example, liquidation cost might also or alternatively represent interest or some other cost associated with holding an asset longer than desired.

In at least some embodiments, computer system 100 generates a liquidity charge related to an expected liquidation cost for a portfolio. This liquidity charge is then added to a performance bond associated with that portfolio. The resulting augmented performance bond represents a performance bond that compensates for liquidation cost and that can thus better account for liquidity risk. As used herein, “LC-compensated performance bond” or “augmented performance bond” refers to a performance bond that has been augmented with a liquidity charge according to one or more embodiments. As also used herein, and unless the context indicates otherwise, “performance bond” without the modifier “LC-compensated” or “augmented” refers to a performance bond which does not include such a liquidity charge.

As a result of research performed by the inventors, a relationship has been discovered between an expected liquidation cost and a value of a performance bond. The discovered relationship between expected liquidation cost and performance bond value is a superlinear function of the form LC=ƒ(PB^{β}), where “LC” is the expected liquidation cost for a portfolio, “PB” is the performance bond for the portfolio, and 1<β<2. The value of β may vary, e.g., based on type of portfolio at issue. Similarly, other details of the function ƒ (e.g., whether there is an offset, a linear factor, etc.) may also vary based on the portfolio at issue.

A performance bond, also known as a “margin,” is typically calculated by an exchange, by a clearinghouse or by some other market entity to help reduce risk associated with a trader failing to fulfill obligations related to a particular asset or group of assets. A performance bond may represent a minimum amount of funds that must be deposited by a customer with a broker, by a broker with a clearinghouse member and/or by a clearinghouse member with a clearinghouse or exchange. These funds may then be used, e.g., to help assure that losses associated with trading positions can be covered. A performance bond typically represents an estimate of the short term profit and loss risk associated with a portfolio and can be determined in various ways. For example, the Standard Portfolio Analysis of Risk (SPAN) system used by CME Group Inc. evaluates overall portfolio risk by calculating the worst possible loss that a portfolio of derivative and physical instruments might reasonably incur over a specified time period (typically one trading day). This is done by computing the gains and losses that the portfolio would incur under different market conditions. Another technique for calculating performance bond uses a “Historical Value at Risk” (HVaR) model. Existing techniques for calculating an initial performance bond are based on an anticipated losses over relatively short holding periods and do not account for the cost of liquidating a portfolio of assets for which there may be no market.

In some embodiments, a performance bond associated with a given portfolio is augmented with a liquidity charge to better account for expected liquidation cost associated with that portfolio. The amount of this liquidity charge is determined based on the pre-augmentation value of the performance bond. As indicated above, it has been determined that expected liquidation cost varies as a superlinear function of performance bond. In some embodiments, however, a liquidity charge table is used instead of a direct calculation of the liquidity charge from a formula. This approach can help speed computation and helps to avoid penalizing small portfolios. A liquidity charge table may include a number of tiers arranged by performance bond value, with one or more of those tiers approximating different portions of an LC=ƒ(LB^{β}) curve. As described below, and consistent with the superlinear relationship between expected liquidation cost and performance bond value, the liquidity charge per dollar (or per other monetary unit) of the performance bond increases for larger performance bonds.

Table 1 is one example of a liquidity charge table for use with interest rate swaps based on underlying obligations or rates denominated in U.S. dollars (USD).

TABLE 1

| | PB lower | PB upper | | |
|---|---|---|---|---|
| row | bound (LBₙ) | bound (UBₙ) | Mult. | Cumul. charge (Cₙ) |
| (n) | (millions of USD) | (millions of USD) | (Mₙ) | (millions of USD) |
| 1 | 0 | 300 | 0.0 | 0 |
| 2 | >300 | 500 | 0.4 | 0 |
| 3 | >500 | 1000 | 0.7 | 80 |
| 4 | >1000 | 2000 | 0.85 | 430 |
| 5 | >2000 | 3000 | 1.05 | 1280 |
| 6 | >3000 | infinite | 1.20 | 2330 |

For a given row (or tier) of Table 1, entries in the second and third columns respectively represent lower and upper bounds for a performance bond. Each fourth column entry represents a multiplier that is applied to a portion of a performance bond corresponding to a particular row. Each fifth column entry represents a cumulative liquidity charge for a particular row. Each fifth column value is calculated by summing the maximum liquidity charges for each preceding row. A maximum liquidity charge for a row is the product of the multiplier on that row and the difference between the PB upper and lower bounds on that row. Because row 1 is the first row, a cumulative liquidity charge of 0 (and a multiplier of 0.0) can be assigned to avoid penalizing smaller portfolios. Because there is no liquidity charge associated with row 1, the cumulative liquidity charge applicable to row 2 is 0. The cumulative liquidity charge for row 3, in millions of USD, is (500−300)*0.4=80. The cumulative liquidity charge for row 4, in millions of USD, is (1000−500)*0.7+80=430. A similar pattern follows for rows 5 and 6.

Table 1 is used to calculate a liquidity charge for a portfolio in the following manner. First, a value of a performance bond for the portfolio is received. Next, the row having upper and lower PB bounds that bracket the received performance bond value is identified. Next, a difference between the performance bond and the lower PB bound for the identified row is determined. Finally, the liquidity charge is generated by multiplying that determined difference by the row multiplier, and by then adding the cumulative liquidity charge for the row.

For example, assume a performance bond for portfolio A has a value $280 million. The upper and lower PB bounds of row 1 bracket the portfolio A performance bond, as 0<280≦300. Thus, the liquidity charge for portfolio A is (280−0)*0.0, or $0. As another example, assume that a performance bond for portfolio B has a value of $1730 million. The upper and lower PB bounds of row 4 bracket the portfolio B performance bond, as 1000<1730≦2000. Thus, the liquidity charge for portfolio B is (1730−1000)*0.85+430, or $1050.5 million.

As can be appreciated from the above, the per monetary unit liquidity charge increases for increasing values of a performance bond. For example, the per dollar liquidity charge for a performance bond of $302 million is ((302−300)*0.4)/302=$0.0027 liquidity charge per dollar of performance bond. The per dollar liquidity charge for a $500 million performance bond is ((500−300)*0.4)/500=$0.16 liquidity charge per dollar of performance bond. This trend continues for larger values of a performance bond and is consistent with the superlinear relationship between expected liquidation cost and performance bond value.

Table 2 is another example of a liquidity charge table. In particular, Table 2 is one example of a liquidity charge table for use with interest rate swaps based on underlying obligations or rates denominated in Euros.

TABLE 2

| | | | | Cumul. charge |
|---|---|---|---|---|
| | PB lower | PB upper | | (Cₙ) |
| row | bound (LBₙ) | bound (UBₙ) | Mult. | (millions |
| (n) | (millions of Euros) | (millions of Euros) | (Mₙ) | of Euros) |
| 1 | 0 | 300 | 0.0 | 0 |
| 2 | >230 | 400 | 0.5 | 0 |
| 3 | >400 | 800 | 0.8 | 85 |
| 4 | >800 | 1500 | 1.0 | 405 |
| 5 | >1500 | 2300 | 1.15 | 1105 |
| 6 | >2300 | infinite | 1.25 | 2025 |

As with Table 1, entries in the second and third columns of Table 2 respectively represent lower and upper bounds for a performance bond. Each fourth column entry represents a multiplier that is applied to a portion of a performance bond corresponding to a particular row. Each fifth column entry represents a cumulative liquidity charge for a particular row and is calculated in the same manner as fifth column entries of Table 1. Table 2 is used to calculate a liquidity charge for a portfolio in a manner similar to the manner in which a liquidity charge is calculated using Table 1. For example, applying Table 2 to a performance bond for a portfolio C having a value of £200 million yields a liquidity charge of (200−0)*0.0=£0. As another example, applying Table 2 to a performance bond for a portfolio D having a value of £2500 million yields a liquidity charge of (2500−2300)*1.25+2025=£2275 million. As with Table 1, the per unit (in this case, Euros) liquidity charge increases for increments of a performance bond corresponding to higher value tiers.

In general, tables such as Tables 1 and 2 can be characterized as stepwise functions. For each row n, the bounds LBₙ and UBₙ establish a different subdomain of input values to the stepwise function. The multiplier (Mₙ) and cumulative charge (Cₙ) in each row define parameters of a subfunction for that row of the form Cₙ+Mₙ*(PB−LBₙ), where “PB” is the value of a portfolio performance bond within the subdomain for row n. In other embodiments, a subfunction for a particular subdomain could be defined in another manner. For example, a subfunction could include terms in addition to Cₙ. As another example, an exponential term could be included. Indeed, in some embodiments the subfunction for each subdomain could be identical. In such an embodiment, the stepwise function would reduce to a single function.

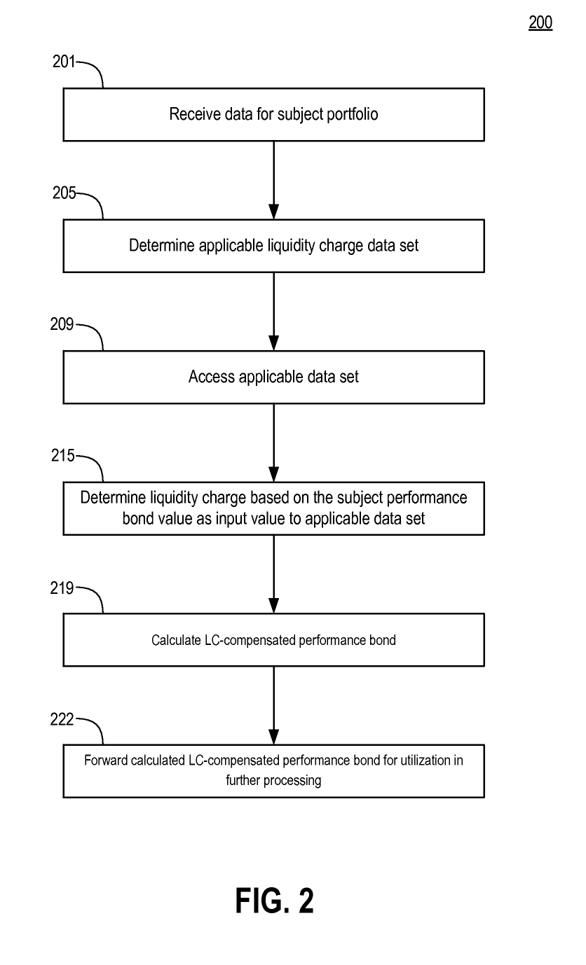

FIG. 2 is a flow chart showing operations in a process 200 performed by exchange computer system 100, in at least some embodiments, to generate a liquidity charge based on a performance bond value of a portfolio. For convenience, a portfolio for which process 200 is being performed will be referred to as a “subject portfolio.” A portfolio may represent an aggregate position of a person, company or other entity in one or more types of financial products. System 100 may perform process 200 separately for each of numerous portfolio types. In some embodiments, the operations of process 200 may be performed by clearing house module 140 (FIG. 1). In other embodiments, the operations of process 200 might be performed by a different module of system 100. In yet other embodiments, the operations of process 200 might be distributed across multiple modules of system 100.

In step 201, system 100 receives data for a subject portfolio. The data received in step 201 may include data identifying the type of assets represented by the subject portfolio. The received data may also include a value of a performance bond for the subject portfolio. The performance bond may have previously been calculated using one of the conventional techniques previously described (e.g., using the SPAN system or using an HVaR model) and/or using other techniques.

In step 205, system 100 determines which of multiple liquidity charge data sets is applicable to the subject portfolio. In some embodiments, system 100 may store a different liquidity charge data set for each of multiple types of portfolios. Each of those different data sets may include different definitions for subdomains and/or subfunctions used to generate a liquidity charge based on a performance bond value. The data sets may be stored in a database associated with module 140, in a database associated with another module of system 100, or elsewhere. System 100 may determine which data set to access based on data received in step 201 and that indicates the type of assets in the subject portfolio.

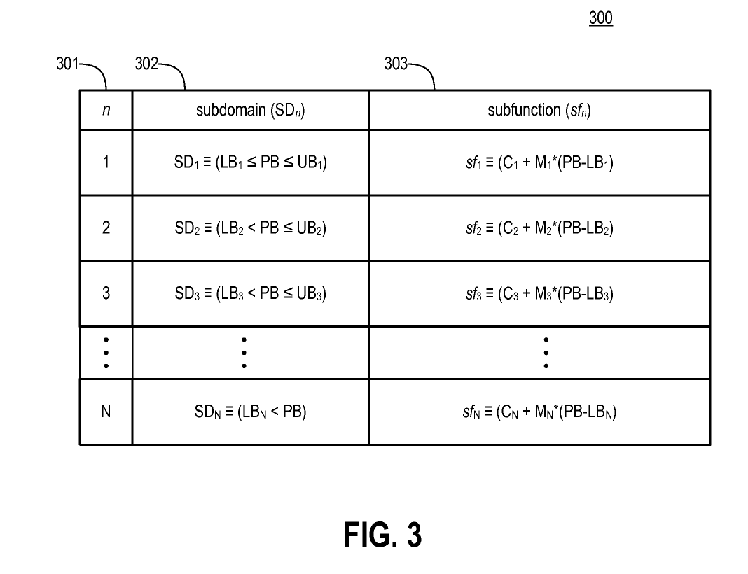

In step 209, system 100 accesses the applicable data set. FIG. 3 shows one example of a liquidity charge data set 300. Although data set 300 is represented in FIG. 3 as a table for convenience of explanation, a liquidity charge data set need not be stored or organized in a table format. As seen in FIG. 3, and as indexed by entries in column 301, data set 300 includes a plurality of rows n. Each row represents a separate record having a subdomain (SDₙ) definition as an entry in column 302 and an associated subfunction (sfₙ) definition as an entry in column 303. Data set 300 includes N records, where N is an arbitrary integer. In the previous examples of Tables 1 and 2, N is six. However, a liquidity charge data set could have more or fewer records. Accordingly, N may be greater or lesser than six in some embodiments.

Each subdomain of data set 300 represents a different set of possible portfolio performance bond values. If a performance bond value of the subject portfolio is a member of a set represented by a particular subdomain SDₙ, the associated subfunction sfₙ can be used to generate a liquidity charge based on that performance bond value. As indicated in connection with the examples of Tables 1 and 2, a subdomain could be defined by values for lower and upper bounds LB and UB, respectively. In other embodiments, a subdomain might be defined differently. For example, a subdomain could be defined using a lower bound and a subdomain size indicating an extent to which performance bond values in a represented set extend beyond the lower bound.

Each subfunction sfₙ of data set 300 describes a how a liquidity charge is to be calculated based on a performance bond having a value in the set represented by associated subdomain SDn. In the example of FIG. 3, each subfunction is in the previously-described form Cₙ+Mₙ*(PB−LBₙ). As indicated in connection with the examples of Tables 1 and 2, a subfunction could be defined as a specific liquidity charge value. For example, a liquidity charge may be zero for performance bond values less than a certain amount (e.g., $300 million or less in Table 1, row 1). As also indicated in the examples of Tables 1 and 2, a subfunction could be defined as a constant plus a product of a defined multiplier and another value. As previously explained, that constant (e.g., CO could represent a cumulative value based on previous subfunctions and the product could be a product of a defined multiplier (e.g., Mₙ) and the amount by which the subject performance bond exceeds a lower bound value for the associated subdomain (e.g., PB−LBₙ). A subfunction could be defined in numerous other ways, however.

In step 215, system 100 determines a liquidity charge based on the subject performance bond value as an input value to the applicable data set. In embodiments where an applicable data set is stepwise function such as data set 300, system 100 first identifies a subdomain that includes the subject performance bond. In particular, system 100 identifies a subdomain representing a set of possible input performance bond values that includes the subject performance bond. After identifying the proper subdomain, system 100 applies the subject performance bond value as input to the associated subfunction.

In step 219, system 100 then calculates an amount representing an augmented performance bond that compensates for expected liquidation cost, i.e., an LC-compensated performance bond. In particular, system 100 adds the liquidity charge determined in step 215 to the performance bond value from the data received in step 201. In step 222, the calculated LC-compensated performance bond amount is forwarded to one or more other modules of system 100 and utilized in further processing. For example, clearinghouse module 140 and/or another system 100 module may cause a message to be sent to a clearing member or to another customer advising that additional funds or other security must be provided so as to bring an account balance up to the value of the amount calculated in step 219. As another example, clearinghouse module 140 and/or another system 100 module may determine, prior to allowing execution of one or more trades, whether an account balance of a clearing member or another customer is at or above the value of the amount calculated in step 219. If so, execution of the trade(s) may be allowed to proceed. If not, execution of the trade(s) may be prevented.

The preceding examples merely represent certain embodiments. In other embodiments, and as previously indicated, a liquidity charge data set may define one or more subfunctions in a some other manner. In some embodiments, a data set may define a single function (e.g., in the form ƒ(PB^{β})) for use with all possible values for an input performance bond. In some embodiments, a data set might require explicit performance of calculations for each of multiple subdomains. For example, instead of defining each subfunction to include a term representing the cumulative value of liquidity charges for each of multiple subdomains corresponding to other increments of a performance bond, a data set may specify performance of a calculation for each corresponding subdomain and then summing of those calculations.

The values for lower bounds, upper bounds and multipliers in Tables 1 and 2 are merely examples of such values according to certain embodiments. In some embodiments, a liquidity charge data set can be generated in the following manner. First, data may first be collected for expected liquidation costs associated with portfolios of a particular type. For example, the portfolio type might include all portfolios that relate to certain types of financial products (e.g., interest rate swaps denominated in a particular currency or based on obligations payable in that type of currency) and having one or more of various structures (e.g., a series of outrights, a series of curve spreads, a series of butterfly spreads, combinations of outrights and spreads, etc.). Data could then be collected for portfolios of that type having varying tenors and levels of DV01 risk. The collected data, which could be obtained from historical data and/or from polls of market participants, could represent the levels of liquidation cost that market participants would charge for each DV01 level, tenor and portfolio structure. For each liquidation cost data point collected, the DV01 level, tenor and structure of a portfolio associated with that liquidation cost data point could then be used to determine a performance bond amount that would normally be associated with such a portfolio. Using conventional curve fitting software, the resulting collection of expected liquidation cost vs. performance bond data points could then be used to determine a function of the previously described form LC=ƒ(PB^{β}).

After determining such a function, a number of intervals can be selected. Each selected interval may correspond to a portion of a curve for the determined function and represent a different tier or subdomain of the liquidity charge data set being created. The number of intervals could be chosen based on factors such as how closely the determined function is to be approximated, desired computational or other simplicity desired, etc. The lower and upper bounds for each tier could then be the beginning and ending points for the represented curve interval. For each interval, a line can be placed so as to approximate the curve within that interval. A multiplier associated with the interval can then be obtained by determining a slope of that line.

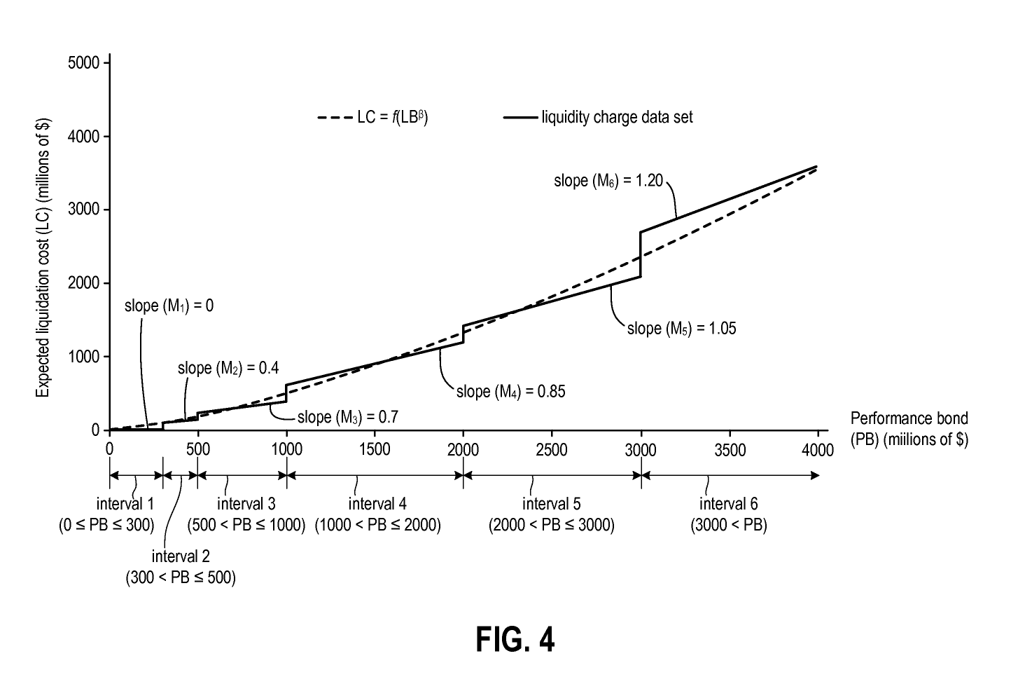

FIG. 4 graphically illustrates creation of a liquidity charge data set based on a determined function for LC. In FIG. 4, a determined function in the form LC=ƒ(PB^{β}) is shown in broken lines. Interval 1 represents a set of performance bond values greater than or equal to a lower bound of zero and less than or equal to an upper bound of $300 million. A slope of the solid line for interval 1, and thus the multiplier M₁ applicable to interval 1, is 0.0. Interval 2 represents a set of performance bond values greater than a lower bound of $300 million and less than or equal to an upper bound of $500 million. A slope of the solid line for interval 2, and thus the multiplier M₂ applicable to interval 2, is 0.4. Interval 3 represents a set of performance bond values greater than a lower bound of $500 million and less than or equal to an upper bound of $1000 million. A slope of the solid line for interval 3, and thus the multiplier M₃ applicable to interval 3, is 0.7. Interval 4 represents a set of performance bond values greater than a lower bound of $1000 million and less than or equal to an upper bound of $2000 million. A slope of the solid line for interval 4, and thus the multiplier M₄ applicable to interval 4, is 0.85. Interval 5 represents a set of performance bond values greater than a lower bound of $2000 million and less than or equal to an upper bound of $3000 million. A slope of the solid line for interval 5, and thus the multiplier M₅ applicable to interval 5, is 1.05. Interval 6 represents a set of performance bond values greater than a lower bound of $3000 million. A slope of the solid line for interval 6, and thus the multiplier M₆ applicable to interval 6, is 1.20.

In some embodiments, there may be multiple liquidity charge data sets for a particular type of portfolio. For example, an exchange may determine a first function ƒ₁ in the form LC₁=ƒ₁(PB^{β1}) and a second function ƒ₂ in the form LC₂=ƒ₂(PB^{β2}). Function ƒ₁ may represent expected liquidation cost in a first set of market conditions and function ƒ₂ may represent expected liquidation cost in a second set of market conditions that are different from the first market conditions. Separate liquidity charge data sets could be created for each of functions ƒ₁ and ƒ₂. In some such embodiments, step 205 of process 200 could include a determination of current market conditions (and/or of market conditions expected to occur when a portfolio might be liquidated) and selection of a liquidity charge data set based on determined and/or expected market conditions.

### CONCLUSION

The foregoing description of embodiments has been presented for purposes of illustration and description. The foregoing description is not intended to be exhaustive or to limit embodiments to the precise form explicitly described or mentioned herein. Modifications and variations are possible in light of the above teachings or may be acquired from practice of various embodiments. For example, one of ordinary skill in the art will appreciate that some steps illustrated in the illustrative figures may be performed in other than the recited order, and that one or more steps illustrated may be optional in one or more embodiments. The embodiments discussed herein were chosen and described in order to explain the principles and the nature of various embodiments and their practical application to enable one skilled in the art to make and use these and other embodiments with various modifications as are suited to the particular use contemplated. Any and all permutations of features from above-described embodiments are the within the scope of the invention.

1. A method comprising:
receiving, in an exchange computer system, a performance bond value for a portfolio, wherein the performance bond value represents a quantity of a monetary unit;
accessing liquidity charge data by the exchange computer system, wherein the liquidity charge data defines
possible input values for a performance bond, and
liquidity charges based on any of the possible input values, wherein a per monetary unit value of a liquidity charge increases for increasing input values;
determining a liquidity charge by the exchange computer system, wherein the liquidity charge is based on the received performance bond value as an input value to the accessed liquidity charge data; and
calculating an augmented performance bond value, by the exchange computer system, by adding the received performance bond value and the determined liquidity charge.

2. The method of claim 1, wherein
the liquidity charge data includes a plurality of subdomains,
each of the subdomains represents a different set of possible input values for a performance bond and is associated with a subfunction, and
determining a liquidity charge includes identifying a subdomain of the plurality such that the received performance bond value is a member of the set represented by the identified subdomain, identifying the subfunction associated with the identified subdomain, and determining the liquidity charge according to the identified subfunction.

3. The method of claim 2, wherein
for each of at least a portion of the subdomains, the associated subfunction includes a multiplier associated with the associated subfunction and with the subdomain, and
determining the liquidity charge includes determining a product of the multiplier associated with the identified subfunction and a difference between the received performance bond value and a lower bound for the identified subdomain.

4. The method of claim 3, wherein
each subdomain corresponds to a maximum liquidity charge,
for each subdomain of at least a portion of the subdomains, the subfunction associated with the subdomain includes an associated cumulative term representing a sum of the maximum liquidity charges corresponding to the subdomains representing lower possible input values than the possible input values corresponding to the subdomain, and
determining the liquidity charge includes adding the cumulative value associated with the identified subfunction to the determined product.

5. The method of claim 4, wherein
each of the associated multipliers is different,
for each subdomain of the plurality, the associated multiplier is greater than any of the multipliers associated with subdomains of the plurality representing sets of lower possible 1 input values than the set of possible input values corresponding to the subdomain.

6. The method of claim 4, wherein
the plurality of subdomains includes at least four subdomains,
first, second, third and fourth of the at least four subdomains respectively represent a lowest set of possible input values, a second lowest set of possible input values, a third lowest set of possible input values and a fourth lowest set of possible input values,
the multiplier associated with the first subdomain is zero.

7. The method of claim 6, wherein at least the second subdomain is associated with a multiplier of less than one.

8. The method of claim 6, wherein at least the second and third subdomains are associated with multipliers of less than one and at least one subdomain of the plurality is associated with a multiplier greater than one.

9. The method of claim 1, wherein
accessing liquidity charge data comprises determining an applicable set of liquidity charge data from multiple sets of liquidity charge data, and
the accessed liquidity charge data is the applicable set of liquidity charge data.

10. One or more non-transitory computer-readable media storing computer executable instructions that, when executed, cause a computer system to perform operations that include:
receiving a performance bond value for a portfolio, wherein the performance bond value represents a quantity of a monetary unit;
accessing liquidity charge data, wherein the liquidity charge data defines
possible input values for a performance bond, and
liquidity charges based on any of the possible input values, wherein a per monetary unit value of a liquidity charge increases for increasing input values;
determining a liquidity charge, wherein the liquidity charge is based on the received performance bond value as an input value to the accessed liquidity charge data; and
calculating an augmented performance bond value by adding the received performance bond value and the determined liquidity charge.

11. The one or more non-transitory computer-readable media of claim 10, wherein
the liquidity charge data includes a plurality of subdomains,
each of the subdomains represents a different set of possible input values for a performance bond and is associated with a subfunction, and
determining a liquidity charge includes identifying a subdomain of the plurality such that the received performance bond value is a member of the set represented by the identified subdomain, identifying the subfunction associated with the identified subdomain, and determining the liquidity charge according to the identified subfunction.

12. The one or more non-transitory computer-readable media of claim 11, wherein
for each of at least a portion of the subdomains, the associated subfunction includes a multiplier associated with the associated subfunction and with the subdomain, and
determining the liquidity charge includes determining a product of the multiplier associated with the identified subfunction and a difference between the received performance bond value and a lower bound for the identified subdomain.

13. The one or more non-transitory computer-readable media of claim 12, wherein
each subdomain corresponds to a maximum liquidity charge,
for each subdomain of at least a portion of the subdomains, the subfunction associated with the subdomain includes an associated cumulative term representing a sum of the maximum liquidity charges corresponding to the subdomains representing lower possible input values than the possible input values corresponding to the subdomain, and
determining the liquidity charge includes adding the cumulative value associated with the identified subfunction to the determined product.

14. The one or more non-transitory computer-readable media of claim 13, wherein
each of the associated multipliers is different,
for each subdomain of the plurality, the associated multiplier is greater than any of the multipliers associated with subdomains of the plurality representing sets of lower possible 1 input values than the set of possible input values corresponding to the subdomain.

15. The one or more non-transitory computer-readable media of claim 13, wherein
the plurality of subdomains includes at least four subdomains,
first, second, third and fourth of the at least four subdomains respectively represent a lowest set of possible input values, a second lowest set of possible input values, a third lowest set of possible input values and a fourth lowest set of possible input values,
the multiplier associated with the first subdomain is zero.

16. The one or more non-transitory computer-readable media of claim 15, wherein at least the second subdomain is associated with a multiplier of less than one.

17. The one or more non-transitory computer-readable media of claim 15, wherein at least the second and third subdomains are associated with multipliers of less than one and at least one subdomain of the plurality is associated with a multiplier greater than one.

18. The one or more non-transitory computer-readable media of claim 10, wherein
accessing liquidity charge data comprises determining an applicable set of liquidity charge data from multiple sets of liquidity charge data, and
the accessed liquidity charge data is the applicable set of liquidity charge data.

19. A computer system comprising:
at least one processor; and
at least one non-transitory memory, wherein the at least one non-transitory memory stores instructions that, when executed, cause the computer system to perform operations that include
receiving a performance bond value for a portfolio, wherein the performance bond value represents a quantity of a monetary unit,
accessing liquidity charge data, wherein the liquidity charge data defines
possible input values for a performance bond, and
liquidity charges based on any of the possible input values, wherein a per monetary unit value of a liquidity charge increases for increasing input values,
determining a liquidity charge, wherein the liquidity charge is based on the received performance bond value as an input value to the accessed liquidity charge data, and
calculating an augmented performance bond value by adding the received performance bond value and the determined liquidity charge.

20. The computer system of claim 19, wherein
the liquidity charge data includes a plurality of subdomains,
each of the subdomains represents a different set of possible input values for a performance bond and is associated with a subfunction, and
determining a liquidity charge includes identifying a subdomain of the plurality such that the received performance bond value is a member of the set represented by the identified subdomain, identifying the subfunction associated with the identified subdomain, and determining the liquidity charge according to the identified subfunction.

21. The computer system of claim 20, wherein
for each of at least a portion of the subdomains, the associated subfunction includes a multiplier associated with the associated subfunction and with the subdomain, and
determining the liquidity charge includes determining a product of the multiplier associated with the identified subfunction and a difference between the received performance bond value and a lower bound for the identified subdomain.

22. The computer system of claim 21, wherein
each subdomain corresponds to a maximum liquidity charge,
for each subdomain of at least a portion of the subdomains, the subfunction associated with the subdomain includes an associated cumulative term representing a sum of the maximum liquidity charges corresponding to the subdomains representing lower possible input values than the possible input values corresponding to the subdomain, and
determining the liquidity charge includes adding the cumulative value associated with the identified subfunction to the determined product.

23. The computer system of claim 22, wherein
each of the associated multipliers is different,
for each subdomain of the plurality, the associated multiplier is greater than any of the multipliers associated with subdomains of the plurality representing sets of lower possible input values than the set of possible input values corresponding to the subdomain.

24. The computer system of claim 22, wherein
the plurality of subdomains includes at least four subdomains,
first, second, third and fourth of the at least four subdomains respectively represent a lowest set of possible input values, a second lowest set of possible input values, a third lowest set of possible input values and a fourth lowest set of possible input values,
the multiplier associated with the first subdomain is zero.

25. The computer system of claim 24, wherein at least the second subdomain is associated with a multiplier of less than one.

26. The computer system of claim 24, wherein at least the second and third subdomains are associated with multipliers of less than one and at least one subdomain of the plurality is associated with a multiplier greater than one.

27. The computer system of claim 19, wherein
accessing liquidity charge data comprises determining an applicable set of liquidity charge data from multiple sets of liquidity charge data, and
the accessed liquidity charge data is the applicable set of liquidity charge data.
